(19) United States
(12) Patent Application Publication
(10) Pub. No.: US 2026/0002510 A1
(43) Pub. Date: Jan. 1, 2026

(54) TIDAL TURBINE

(71) Applicant: Tidal Technologies Limited, North Yorkshire (GB)

(72) Inventor: James Alfred Carron SCRIMGEOUR, North Yorkshire (GB)

(21) Appl. No.: 18/881,460

(22) PCT Filed: Jun. 26, 2023
(86) PCT No.: PCT/GB2023/051665

§ 371 Date: Jan. 6, 2025

(30) Foreign Application Priority Data
Jul. 7, 2022 (GB) 2210005.1

(51) Int. Cl. F03B 13/26; E02B 17/00; F03D 9/00

(52) U.S. Cl. CPC F03B 13/26; E02B 17/00; F03D 9/008; E02B 2017/0091; F05B 2220/703

(57) ABSTRACT

The present disclosure relates to a tidal turbine for converting kinetic energy of water into electrical energy. An aspect of the disclosure provides a tidal turbine assembly (100) comprising: a first turbine (110), comprising a first plurality of foils (111-113), that is configured, in use, to rotate around an upright axis that is upright relative to the sea bed; and a second turbine (120), comprising a second plurality of foils (211-213), that is configured, in use, to rotate around an upright axis that is upright relative to the sea bed; wherein the first turbine (110) and the second turbine (120) are coupled by a support beam (130) that is configured to be, in use, above the sea level; and wherein the support beam (130) is coupled to a support column (140) to support the support beam, in use, above the sea level.

### FIELD OF THE INVENTION

The present disclosure relates to a tidal turbine assembly for converting kinetic energy of water into electrical energy. In particular, the present disclosure relates to a tidal turbine assembly comprising at least one turbine which has an upright vertical rotational axis in use.

### BACKGROUND

The concept of offshore tidal turbines in not new, however the majority of existing concepts, none of which have reached full market implementation, have used some form of horizontal axis turbine with all working parts under water. Under water horizontal axis turbines are extremely expensive to develop, install and maintain and this has meant that no existing concepts have been able to demonstrate that they are economically viable. Tidal Technologies has taken a completely different approach using vertical axis turbines. This innovative concept is designed to sit on the seabed but allows for all of the mechanics, generators and electrical equipment to be installed out of the water, above the highest tide level, in storm proof housings. This dramatically reduces the complexity and costs of construction because it allows for the use of standard “off the shelf” equipment. It also makes installation and maintenance much cheaper. It also allows each turbine to sweep a much larger area of water from just below the lowest tide level to just above the sea bed.

A scaled model of TT2 has been tested in the confidential facilities of QinetiQ's ship testing tank in Gosport. This is one of the most sophisticated hydrodynamic testing facilities in the world, built for the Navy in 1930 where all MOD vessels have been tested since. The results of this testing were extremely successful confirming all of the desktop work that was carried out in advance during the design process. Following testing, the developers are now confident that each TT2 can be developed to produce approximately 1 megawatt of 100% predictable clean electricity at a levelized cost of energy (LCOE) to compete favourably with offshore wind turbines.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

An aspect of the disclosure provides a tidal turbine assembly comprising: a first turbine, comprising a first plurality of foils, that is configured, in use, to rotate around an upright axis that is upright relative to the sea bed; and a second turbine, comprising a second plurality of foils, that is configured, in use, to rotate around an upright axis that is upright relative to the sea bed; wherein the first turbine and the second turbine are coupled by a support beam that is configured to be, in use, above the sea level; and wherein the support beam is coupled to a support column to support the support beam, in use, above the sea level.

Advantageously, renewable electrical energy conversion is provided by the tidal turbine assembly. Tidal movements of water are regular and the electrical power output obtainable, using the present tidal turbine assembly, can be determined in advance. Therefore, the negative consequences which arise from the uncertainties in power output present in other renewable energy fields (e.g. wind and solar) are not manifest for the present tidal turbine assembly.

Advantageously, providing two turbines may reduce the net torque on the tidal turbine assembly which in turn may reduce the amount of force required to secure the tidal turbine to the seabed.

In examples, the support beam is disposed above the highest tide level.

In examples, one or both of the turbines may be a Darrieus-type turbine.

The support column may be connected to a gravity base to support the support column in an upright orientation relative to the seabed in use.

Each turbine may comprise a turbine shaft about which the turbine rotates, wherein the turbine shaft is coupled to the support beam at one end and to the gravity base at the other end. In examples, a bearing is disposed between respective turbine shafts and the support beam. In examples, a bearing is disposed between respective turbine shafts and the gravity base. In examples, the foil support is movable up and down the turbine shaft to thereby permit, in use, movement of the foils (or a part thereof) out of the water.

In examples, the foils of each turbine are configured so that in the event that a net rotational force applied to the foils, the components of the turbine, namely, the turbine shaft, the foil support and the foils rotate in unison about the rotational axis of the turbine.

In examples, each turbine may comprise a turbine shaft about which the turbine rotates, wherein the turbine shaft is only coupled to the support beam.

In examples, the support column is provided by a monopile. Advantageously, the heavy gravity base does not need to be floated and towed from the shore to an installation location.

The tidal turbine assembly may be coupled to a monopile of a wind turbine e.g. the monopole of an existing or new wind turbine. Advantageously, fewer components may be required to provide the tidal turbine assembly which may reduce costs.

The tidal turbine assembly may further comprise a respective power generating portion mounted to the support beam proximate to each of the respective first and second turbines. Advantageously, rotation of the first and second turbines may be converted into electrical energy by the respective power generating portions.

Each turbine may comprise a turbine connected to the support beam and a foil support for supporting the respective plurality of foils via a respective plurality of foil connections, and wherein the foil support is configured to be movable up and down the turbine shaft (e.g. to thereby provide, in use, movement of the foils up and down relative to the sea bed to lift the foil connections out of the water). Advantageously, the foils can be replaced or removed for maintenance without the need to take the tidal turbine assembly back to shore or lifting the whole assembly out of the water and onto a ship which may be required for typical horizontally orientated turbine assemblies.

In examples, the foil support of one turbine is configured to be movable independently of the foil support of another turbine.

Each of the first and second plurality of foils may only be connected to the respective foil support at a proximal end that is distal to the sea bed in use. Connecting the foils at the proximal ends may permits easy connection and replacement thereof. In contrast if a connection between the foil support and the foil was provided at the distal end of the foil, then maintenance and/or replacement of the foil may be more difficult. For example, maintenance and/or replacement would either require using a diver or taking the whole assembly back to shore or lifting the whole assembly out of the water and onto a ship which may be required for typical horizontally orientated turbine assemblies.

Each foil of the first and second plurality of foils is weighted at a distal end proximate to the sea bed in use with positive buoyancy to float vertically to allow easy connection and replacement. Advantageously, the foil connection may float at the surface of the water to permit simplified connection of the foils to the foil support and may forgo the need to provide additional apparatus to float the foil.

In examples, each foil is weighted so that the foils is negatively buoyant in water (e.g. fresh water, or sea water). Advantageously, the weight of the gravity base may be reduced.

The first turbine may be configured to rotate about an axis parallel to the axis about which the second turbine rotates.

Each turbine may comprise three foils. In examples, a turbine may comprise any of: one foil; two foils; three foils; four foils; five foils; or more.

The plurality of foils of each turbine may be symmetric. Advantageously, the foils may be rotated by water moving in any direction oblique to the upright rotational axis of said foils.

The support column may be profiled to reduce tidal forces on the structure. Advantageously, the means of securing the tidal turbine assembly to the seabed may be designed to withstand higher tidal forces which may reduce the overall cost of the assembly.

In other examples, the support column may not be profiled which may reduce the overall cost of producing the assembly.

The support column may be hollow and configured to be buoyant for floating prior to installation. At the point of installation the support column may be flooded with sea water. For example, the tidal turbine assembly may be towed to an installation location rather than carried upon a ship. Advantageously, the size of the ship required to move the tidal turbine assembly from the shore to an installation location may be reduced which may in turn reduce the installation cost of the tidal turbine assembly.

In examples, the support column supports the support beam between the first and second turbines such that the first and second turbines are on either side of the support column. Advantageously, providing two turbines may reduce the net torque on the tidal turbine assembly which in turn may reduce the amount of force required to secure the tidal turbine to the seabed.

In examples, the tidal turbine assembly comprises a pair of support columns for supporting the support beam, in use, above the sea level. In examples, pair of support columns at either end of the support beam could be provided, with one or more turbines disposed therebetween. Said example may comprise any of: one turbine; two turbines; three turbines; four turbines or more. In such examples, the turbines may be disposed between the pair of support columns. In such examples, the turbines arranged equidistantly along a support beam with a support column disposed between adjacent turbines.

An aspect of the disclosure provides a tidal turbine assembly comprising: a first turbine, comprising a first turbine shaft and a first plurality of foils, that is configured, in use, to rotate around an upright axis that is upright relative to the sea bed; wherein the first turbine shaft is coupled to a support beam; and wherein the support beam is coupled to a support column to support the support beam, in use, above the sea level; and wherein the first turbine comprises a foil support for supporting the respective plurality of foils via a respective plurality of foil connections, and wherein the foil support is configured to be movable up and down relative to the first turbine shaft to thereby permit the plurality of foil connections to be lifted out of the water.

In examples, the tidal turbine assembly may further comprise a second turbine, comprising a second turbine shaft and a second plurality of foils, that is configured, in use, to rotate around an upright axis that is upright relative to the sea bed; wherein the second turbine shaft is also coupled to the support beam; and wherein the second turbine also comprises a foil support for supporting the respective plurality of foils via a respective plurality of foil connections, and wherein the foil support of the second turbine is also configured to be movable up and down relative to the second turbine shaft to thereby permit the plurality of foil connections to be lifted out of the water.

In examples, the tidal turbine assembly may further comprise a support column for supporting the support beam above the sea level in use, wherein the support column is connected to a gravity base to support the support column in an upright orientation relative to the seabed in use.

In examples, each turbine shaft rotates about a turbine axis, wherein each turbine shaft is coupled to the support beam at one end and to the gravity base at the other end.

An aspect of the disclosure provides an offshore wind turbine comprising a tidal turbine assembly, the tidal turbine assembly comprising: a first turbine, comprising a first plurality of foils, that is configured, in use, to rotate around an upright axis that is upright relative to the sea bed; and a second turbine, comprising a second plurality of foils, on an opposite side of the offshore wind turbine to the first turbine, the second turbine configured, in use, to rotate around an upright axis that is upright relative to the sea bed; wherein the first turbine and the second turbine are coupled to the offshore wind turbine by a support beam that is configured to be, in use, above the sea level.

In examples, each turbine comprises a turbine shaft and a foil support connected thereto, the foil support for supporting the respective plurality of foils via a respective plurality of foil connections, and wherein the foil support is configured to be movable up and down relative to the turbine shaft to permit the plurality of foil connections to be lifted out of the water.

In examples, each of the first and second plurality of foils are only connected to the respective foil support at a proximal end that is distal to the sea bed in use.

An aspect of the disclosure provides a tidal turbine assembly comprising: a first turbine, comprising a first plurality of foils, that is configured, in use, to rotate around an upright axis that is upright relative to the sea bed; and a second turbine, comprising a second plurality of foils, that is configured, in use, to rotate around an upright axis that is upright relative to the sea bed; a third turbine, comprising a third plurality of foils, that is configured, in use, to rotate around an upright axis that is upright relative to the sea bed; wherein the first turbine and second turbine, and third turbine are coupled by a support beam that is configured to be, in use, above the sea level; and wherein the support beam is coupled to two support columns to support the support beam, in use, above the sea level.

A tidal turbine assembly is provided configured to extract energy from tidal waters which advantageously is a predictable source of renewable energy.

In examples, three support columns or four columns may be provided. Advantageously, increasing the number of support columns may improve the stability of the tidal turbine assembly.

### DRAWINGS

Embodiments of the disclosure will now be described, by way of example only, with reference to the accompanying drawings, in which:

FIG. 1 shows a side plan view of an example of the tidal turbine assembly of the present invention;

FIG. 2 shows a top plan view of the tidal turbine assembly of FIG. 1;

FIG. 3A shows a plan side view of the tidal turbine assembly of FIG. 1 with foils lowered in the operational position;

FIG. 3B shows a plan side view of the tidal turbine assembly of FIG. 1 with foils raised in the maintenance position;

FIG. 4 illustrates a side plan view of a tidal turbine assembly 100′ according to the disclosure.

In the drawings, like reference numerals indicate like elements.

### SPECIFIC DESCRIPTION

Embodiments of the claims relate to a tidal turbine assembly configured to convert kinetic energy of water into electrical energy. In particular, the kinetic energy of the water may be provided by tidal forces which provide regular and predictable water movement which is Embodiments of the claims comprise one or more turbines which

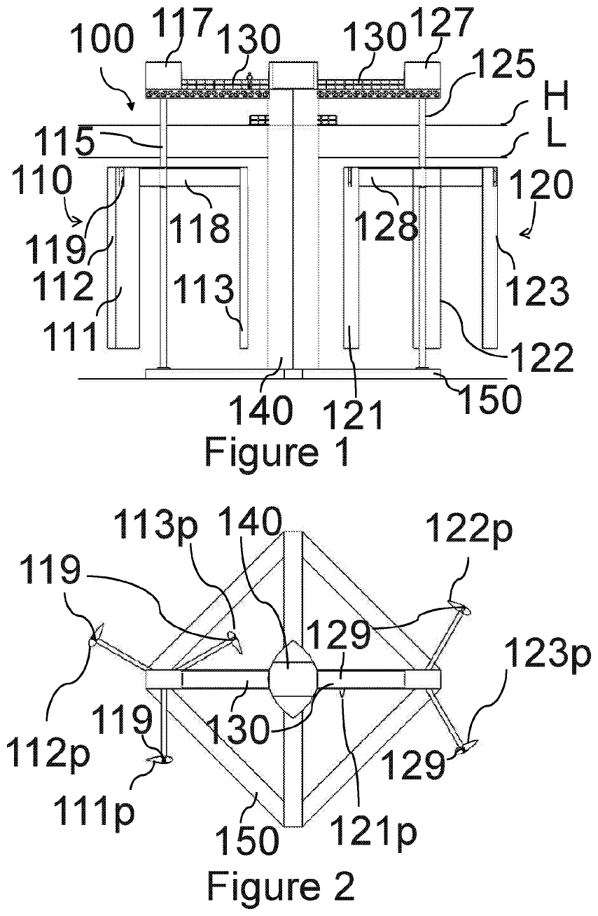

FIG. 1 shows a side plan view of an example of the tidal turbine assembly 100 of the present invention; FIG. 2 shows a top plan view of the tidal turbine assembly of FIG. 1.

The tidal turbine assembly 100 comprises: a first turbine 110; a second turbine 120; a support beam 130; a support column 140; and, a gravity base 150.

The first turbine 110 is connected to the support beam 130. The second turbine 120 is connected to the support beam 130. The support column 140 connects the support beam 130 to the gravity base 150.

The first turbine 110 comprises: a first plurality of foils, comprising a first A foil 111, a first B foil 112, and a first C foil 113; a first turbine shaft 115; a first power generating portion 117; a first foil support 118; a first plurality of foil connections 119. The first turbine 110 rotates about a first turbine axis.

The second turbine 120 comprises: a second plurality of foils, comprising a second A foil 121, a second B foil 122, and a second C foil 123; a second turbine shaft 125; a second power generating portion 127; a second foil support 128; a second plurality of foil connections 129. The second turbine 110 rotates about a second turbine axis.

Each foil 111-113 121-123 has a proximal end, p, and a distal end d, wherein each of the proximal ends is disposed closer to the support beam 130 than the respective distal end.

Each foil 111-113 121-123 has a foil length defined as the length between the proximal end p and the distal end d. The foils have the same length. The length of the foils is less than the lowest water level L (e.g. the depth of water during the lowest tide).

In examples, the foils may have lengths which are not equal to one another. For example, for a given plurality of foils, the A foil may be the longest foil, the C foil may be the shortest foil and the B foil may have a length which differs from that of the A foil and C foil.

Each foil 111-113 121-123 is positively buoyant so that free foils (e.g. foils removed for maintenance or towed by sea to replace an existing foil) float at the surface of water. Advantageously, loss or costly recover of the foil from the seabed is prevented.

Each foil 111-113 121-123 is weighted at its distal end so that each foil floats vertically (i.e. the proximal end floats at the surface and the distal end is disposed below the proximal end). Advantageously, weighting the foil in this manner permits easy connection of the proximal end of a foil to the respective foil support.

The first plurality of foils (first A foil 111, first B foil 112, first C foil 113) is connected to the first foil support 118 by the first plurality of foil connections 119 at the proximal ends of said coils. The proximal end 111p of the first A foil 111 is connected to the first foil support 118 by one of the foil connections 119. Likewise, the proximal end 112p of the first B foil 112 is connected to the first foil support 118 by another foil connection 119, and the proximal end 113p of the first C foil 113 is connected to the first foil support 118 by a further foil connections 119.

In a similar manner, the second plurality of foils (second A foil 121, second B foil 122, second C foil 123) are connected to the second foil support 128 by a second plurality of foil connections 129 at the proximal ends of said coils.

Connecting the foils at the proximal ends permits easy connection and replacement thereof (e.g. in comparison to providing a connection at a distal end, which would either require using a diver or taking the whole assembly back to shore and/or lifting the whole assembly out of the water and onto a ship which is required for typical horizontally orientated turbine assemblies).

The first plurality of foils 111-113 are equidistantly arranged about a common centre i.e. the first plurality of foils equiangularly arranged to lie on the curved face of a cylinder. The first plurality of foils 111-113 are configured so that, when the tidal turbine assembly is installed for use, water moving past the first plurality of foils imparts a net rotational force on the first plurality of foils about their common centre. The first foil support 118 is configured to transmit said net rotational force to the first turbine shaft 115 to thereby rotate the first turbine shaft 115.

Similarly, the second plurality of foils 121-123 are equidistantly arranged about another common centre. The second plurality of foils 121-123 are configured so that, when the tidal turbine assembly is installed for use, water moving past the second plurality of foils imparts a net rotational force on the second plurality of foils about their common centre. The second foil support 128 is configured to transmit said net rotational force to the second turbine shaft 125 to thereby rotate the second turbine shaft 125.

The foils in a given plurality of foils are symmetric to thereby permit rotation of the plurality of the foils about their rotational axis when impinged upon by water moving in any direction oblique to the upright rotational axis of said plurality of foils.

In examples, the foils in a given plurality of foils may be asymmetric. Advantageously, said foils may permit rotation of the plurality of the foils about their rotational axis when impinged upon by water moving in any direction oblique to the upright rotational axis of said plurality of foils.

The first foil support 118 is movable relative to the support column 140. The first foil support 118 is moveable in a lateral direction along the upright rotational axis of the first turbine shaft 115 (i.e. the first rotational axis). When installed for use, movement of the first foil support 118 relative the support column 140 provides movement of the first foil support 118 relative to the seabed.

The second foil support 128 is movable relative to the support column 140. The second foil support 128 is moveable in a lateral direction along the upright rotational axis of the second turbine shaft 125 (i.e. the second rotational axis). When installed for use, movement of the second foil support 128 relative the support column 140 provides movement of the second foil support 128 relative to the seabed.

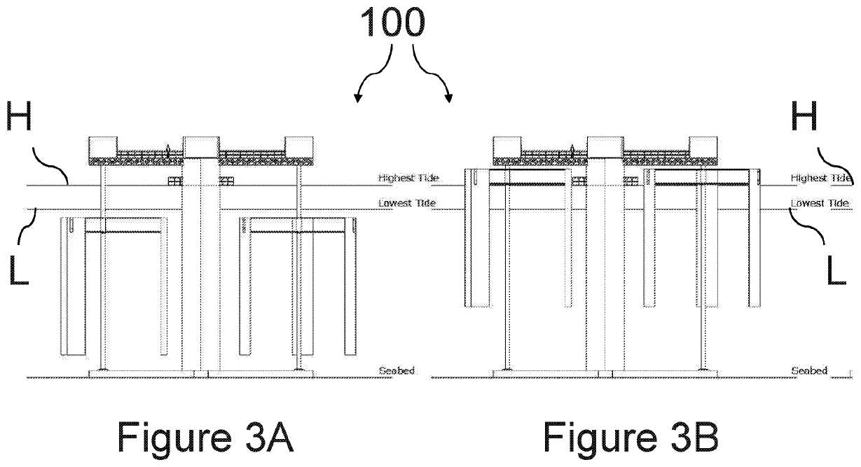

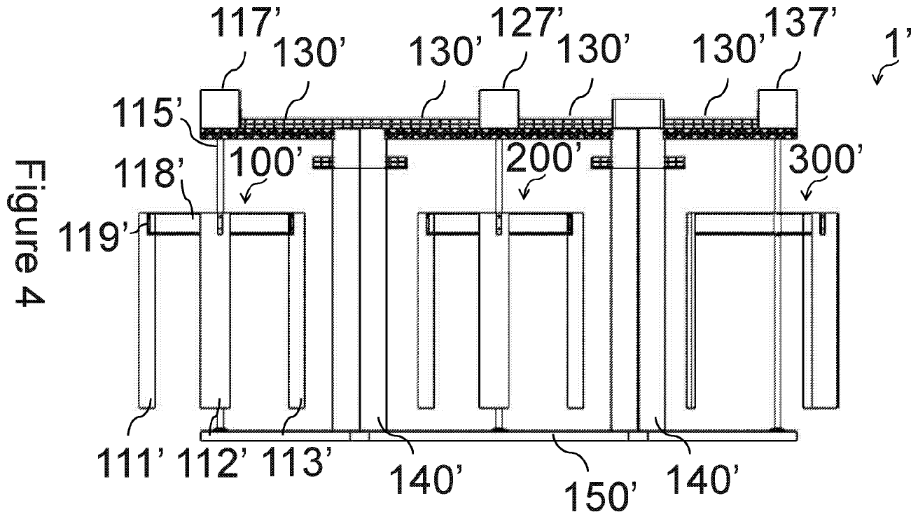

Moreover, the lateral movement of the foil supports 118 128 may permit the foil connections to be raised out of the water (see FIG. 3B which illustrates the assembly in a maintenance position). Advantageously, one or more of the foils 111-113 121-123 can be replaced or removed for maintenance without the need to take tidal turbine assembly 100 back to shore or lifting the whole assembly out of the water and onto a ship which is required for typical horizontally orientated turbine assemblies. The lateral movement of the first foil support 118 along the rotational axis of the first turbine shaft 115 may be independent of the lateral movement of the second foil support 128 along the rotational axis of the second turbine shaft 125 (and vice versa).

After maintenance has been performed, the foil supports 118 128 are moved down the respective turbine shafts into an operational position (shown in FIG. 3A).

The first plurality of foils 111-113 is coupled to the first turbine shaft 115. The first turbine shaft 115 is configured to rotate about the first upright rotational axis. The second plurality of foils 121-123 is coupled to the second turbine shaft 125. The second turbine shaft 125 is configured to rotate about the second upright rotational axis. The first upright axis is parallel to a second upright axis (about which the second turbine shaft 125 rotates).

The first turbine shaft 115 is configured to rotate when a net rotational force is applied to the turbine by the first plurality of foils 111-113 (connected thereto by the first foil support 118). Likewise, the second turbine shaft 125 is configured to rotate when a net rotational force is applied to the turbine by the second plurality of foils 121-123 (connected thereto by the second foil support 128). When the tidal turbine assembly is installed for use, the first rotational axis is vertical with reference to the seabed (i.e. approximately perpendicular to the seabed).

The first turbine shaft 115 is coupled to the support beam 130. The first turbine shaft 115 is coupled to the gravity base 150. The first turbine shaft 115 is rotatable relative to the support beam 130 and the gravity base 150 about the first rotational axis which extends between the support beam 130 and the gravity base 150. The first rotational axis is upright in use i.e. when the tidal turbine assembly is installed for use. A first bearing is disposed between the first turbine shaft 115 and the support beam 130 and a second bearing is disposed between the first turbine shaft 115 and the gravity base 150 to reduce friction therebetween due to rotation of the first turbine shaft 115.

Similarly, the second turbine shaft 125 is coupled to the support beam 130. The second turbine shaft 125 is coupled to the gravity base 150. The second turbine shaft 125 is rotatable relative to the support beam 130 and the gravity base 150 about the second rotational axis which extends between the support beam 130 and the gravity base 150. The second rotational axis is upright in use i.e. when the tidal turbine assembly is installed for use. A third bearing is disposed between the second turbine shaft 125 and the support beam 130 and a fourth bearing is disposed between the second turbine shaft 125 and the gravity base 150 to reduce friction therebetween due to rotation of the first turbine shaft 125.

In examples, the turbine shafts may be coupled to the support beam only (i.e. not coupled to the gravity base).

The first turbine shaft 115 is coupled to the first power generating portion 117. The first power generating portion 117 comprises a first generator which is configured to generate power when the first turbine shaft 115 is turned. Similarly, the second turbine shaft 125 is coupled to the second power generating portion 127. The second power generating portion 127 comprises a second generator which is configured to generate power when the second turbine shaft 125 is turned.

The first power generating portion 117 and the second power generating portion 127 are disposed on the support beam 130. When installed for use, the first power generating portion 117 and the second power generating portion 127 are disposed above the water level (e.g. above the water level of the highest tide H). Advantageously, maintenance of the power generating portions 117 127 is comparatively easy given the relative ease of access thereto (i.e. is not disposed under water or in a confined space) in comparison to other tidal turbine assemblies. Advantageously, the power generating portions 117 127 can be formed of components which are not specially adapted for use under the water (e.g. so-called off-the-shelf components can be used to form the power generating portions) which can reduce the overall manufacturing and maintenance costs of the tidal turbine assembly.

Electrical power may be stored at each of the power generating portions or in an energy storage device (e.g. a battery) disposed at the tidal turbine assembly.

The power generating portions may be connected to an electrical power grid for distribution of said electrical power to electrical devices connected to the grid. In examples wherein energy generated by the power generating portions is stored at the tidal turbine assembly in an energy storage device, the energy storage device may be connected to an electrical power grid for distribution of said power.

The support column 140 is hollow and configured to be buoyant for floating prior to installation. This permits the tidal turbine assembly 100 to be towed to an installation location rather than carried upon a ship. Advantageously, the size of the ship required to move the tidal turbine assembly from the shore to an installation location may be reduced which may in turn reduce the installation cost of the tidal turbine assembly.

The gravity base 150 is a weighted base structure. The gravity base 150 is weighted so that when the tidal turbine assembly 100 is kept in a given installation location relative to the seabed, thereby preventing damage to the tidal turbine system. In examples, the gravity base can be replaced by a driven monopole. The gravity base 150 supports the support column 140 in an upright orientation relative to the seabed in use. This ensures that the support beam 130 and the first and second power generating portions 117 and 127 are disposed above sea level.

### Installation

An aspect of the disclosure provides a method of installing the tidal turbine assembly.

The method of installing the tidal turbine assembly comprises providing a tidal turbine assembly e.g. a tidal turbine assembly according to the present disclosure. Next the tidal turbine assembly is towed to an installation location. The tidal turbine assembly is configured to be buoyant so that the assembly can be floated and towed to the installation location. Tidal turbine assemblies 100 of the present disclosure comprise a hollow support column 140. The hollow support column 140 provides at least part of the required buoyancy to float the tidal turbine assembly 100.

Once the tidal turbine assembly is disposed above the installation location, the buoyancy is removed. In the present example, the hollow interior of the support column 140 is flooded (e.g. with sea water) which reduces the overall buoyancy of the assembly. The tidal turbine assembly then sinks to the seabed. The gravity base 150 is designed (e.g. sufficiently weighted and/or shaped) so that once the assembly is sunk to the installation location, the gravity base is immovable relative to the seabed in the response to natural force (e.g. water forces due to currents and tides). Advantageously, this may simplify installation e.g. divers may not be required to secure the base to the seabed.

In examples, the gravity base may be secured to the seabed. In alternative examples, a monopile may be provided in the place of the gravity base. In such examples, the monopile is driven into the seabed to thereby secure the tidal turbine assembly.

### Use

An aspect of the disclosure provides a method of use of the tidal turbine assembly.

When the tidal turbine assembly 100 is installed at an installation location then the assembly may be used to convert the kinetic energy of tidal waters into electrical energy. The foils are disposed below the level of the lowest tide L (see FIG. 3A).

From low tide to high tide there is a net movement of water in a first direction. The water moves past the first and second turbine 110 120 which causes a corresponding rotation of the turbines 110 120. The rotation of the turbines 110 120 generates electrical energy at the first and second power generating portions 117 127. The generated electrical energy can be sent to the power grid onshore.

Similarly, from high tide to low tide there is a net movement of water in a second direction (e.g. generally opposite to the direction of the first direction). The water moves past the first and second turbine 110 120 which causes a corresponding rotation of the turbines 110 120. The rotation of the turbines 110 120 generates electrical energy at the first and second power generating portions 117 127. The generated electrical energy can be sent to the power grid onshore.

As the turbines are symmetrical, they will rotate irrespective of the new movement direction of the water. Advantageously, energy can be generated during both tidal movements.

Examples described herein refer to sea water and the sea bed but it will be appreciated that the present invention may also be used in fresh water or brackish water.

Examples described herein refer to extracting energy from tidal waters but it will be appreciate that the present invention may also be used in any body of water which exhibits a net flow of water (e.g. rivers).

FIG. 4 illustrates a side plan view of a tidal turbine assembly 1′ according to the disclosure. The tidal turbine assembly 1′ is similar to that illustrated in FIGS. 1 to 3B with the difference that the tidal turbine 1′ illustrated in FIG. 4 comprises three turbines whereas the tidal turbine illustrated in FIGS. 1 to 3B comprises two turbines.

The tidal turbine assembly 1′ comprises: a first turbine 100′; a second turbine 200′; a third turbine 300′; a support beam 130′; two support columns 140′; a gravity base 150′; and three power generating portions.

The first turbine 100′ is identical to the first turbine 110 described above. For completeness, first turbine 100′ comprises: a first A foil 111′, a first B foil 112′, and a first C foil 113′; a first turbine shaft 115′; a first power generating portion 117′; a first foil support 118′; a first plurality of foil connections 119′. The first turbine 100′ rotates about a first turbine axis. Rotation of the first turbine 100′ about the first turbine axis generates electrical power in the first power generating portion 117′.

The second turbine 200′ and third turbine 300′ are identical to the second turbine 120 and third turbine 130 described above. The second turbine 200′ is connected to a second power generating portion 117′ and the third turbine 300′ is connected to a third power generating portion 117. The second turbine 200′ rotates about a second turbine axis and the third turbine 300′ rotates about a third turbine axis. Rotation of the second turbine 200′ about the second turbine axis generates electrical power in the second power generating portion 117′ and similarly rotation of the third turbine 300′ about the third turbine axis generates electrical power in the third power generating portion 117′.

The power generating portions 117′ are connected to the support beams 130′. Each support beam 130′ is connected to at least one support column 140′. Each of the support columns 140′ is connected to the gravity base 150′.

The tidal turbine assembly 1′ is used in the same manner as tidal turbine assembly 100 described herein.

Importantly tidal turbine assembly 1′ illustrates how a general tidal turbine assembly having any number of turbines may be provided. It will be evident to one of ordinary skill in the art that an additional turbine can be added to any given tidal turbine assembly described herein by noting the differences between tidal turbine assembly 1′ and tidal turbine assembly 100 and applying these differences to a given tidal turbine assembly.

Providing a tidal turbine assembly comprising more than two turbines may advantageously increase the power yield of a given tidal turbine assembly.

It will be appreciated from the discussion above that the embodiments shown in the Figures are merely exemplary, and include features which may be generalised, removed or replaced as described herein and as set out in the claims. In the context of the present disclosure other examples and variations of the apparatus and methods described herein will be apparent to a person of skill in the art.

1. A tidal turbine assembly comprising:
a first turbine, comprising a first plurality of foils, that is configured, in use, to rotate around an upright axis that is upright relative to the sea bed; and
a second turbine, comprising a second plurality of foils, that is configured, in use, to rotate around an upright axis that is upright relative to the sea bed;
wherein the first turbine and the second turbine are coupled by a support beam that is configured to be, in use, above the sea level;
and wherein the support beam is coupled to a support column to support the support beam, in use, above the sea level.

2. The tidal turbine assembly of claim 1 wherein the support column is connected to a gravity base to support the support column in an upright orientation relative to the sea bed in use.

3. The tidal turbine assembly of claim 2 wherein each turbine comprises a turbine shaft wherein each turbine rotates about a turbine axis, wherein the turbine shaft is coupled to the support beam at one end and to the gravity base at the other end.

4. The tidal turbine assembly of claim 1 or 2 wherein each turbine comprises a turbine shaft wherein each turbine rotates about a turbine axis, wherein the turbine shaft is only coupled to the support beam.

5. The tidal turbine assembly of claim 1 wherein the support column is provided by a monopile.

6. The tidal turbine assembly of claim 5 wherein the tidal turbine assembly is coupled to a monopile of a wind turbine.

7. The tidal turbine assembly of claim 1 further comprising a respective power generating portion mounted to the support beam proximate to each of the respective first and second turbines.

8. The tidal turbine assembly of claim 8 wherein each turbine comprises a turbine shaft and a foil support for supporting the respective plurality of foils via a respective plurality of foil connections, and wherein the foil support is configured to be movable up and down relative to the turbine shaft to thereby permit the plurality of foil connections to be lifted out of the water.

9. The tidal turbine assembly of claim 8 wherein the foil support of one turbine is configured to be movable independently of the foil support of another turbine.

10. The tidal turbine assembly of claim 8 wherein each of the first and second plurality of foils are only connected to the respective foil support at a proximal end that is distal to the sea bed in use.

11. The tidal turbine assembly of claim 1 wherein each foil of the first and second plurality of foils is weighted at a distal end proximate to the sea bed in use with positive buoyancy to float vertically to allow easy connection and replacement.

12. The tidal turbine assembly of claim 1 wherein the first turbine is configured to rotate about an axis parallel to the axis about which the second turbine rotates.

13.-16. (canceled)

17. The tidal turbine assembly of claim 1 wherein the support column supports the support beam between the first and second turbines such that the first and second turbines are on either side of the support column.

18. The tidal turbine assembly of claim 1 comprising a pair of support columns for supporting the support beam, in use, above the sea level.

19. A tidal turbine assembly comprising:
a first turbine, comprising a first turbine shaft and a first plurality of foils, that is configured, in use, to rotate around an upright axis that is upright relative to the sea bed;
wherein the first turbine shaft is coupled to a support beam;
and wherein the support beam is coupled to a support column to support the support beam, in use, above the sea level; and
wherein the first turbine comprises a foil support for supporting the respective plurality of foils via a respective plurality of foil connections, and wherein the foil support is configured to be movable up and down relative to the first turbine shaft to thereby permit the plurality of foil connections to be lifted out of the water.

20. The tidal turbine assembly of claim 19 further comprising a second turbine, comprising a second turbine shaft and a second plurality of foils, that is configured, in use, to rotate around an upright axis that is upright relative to the sea bed;
wherein the second turbine shaft is also coupled to the support beam; and
wherein the second turbine also comprises a foil support for supporting the respective plurality of foils via a respective plurality of foil connections, and wherein the foil support of the second turbine is also configured to be movable up and down relative to the second turbine shaft to thereby permit the plurality of foil connections to be lifted out of the water.

21. The tidal turbine assembly of claim 20 further comprising a support column for supporting the support beam above the sea level in use, wherein the support column is connected to a gravity base to support the support column in an upright orientation relative to the sea bed in use.

22. The tidal turbine assembly of claim 21 wherein each of the turbine shafts is coupled to the support beam at one end and to the gravity base at the other end.

23. An offshore wind turbine comprising a tidal turbine assembly, the tidal turbine assembly comprising:
a first turbine, comprising a first plurality of foils, that is configured, in use, to rotate around an upright axis that is upright relative to the sea bed; and
a second turbine, comprising a second plurality of foils, on an opposite side of the offshore wind turbine to the first turbine, the second turbine configured, in use, to rotate around an upright axis that is upright relative to the sea bed;
wherein the first turbine and the second turbine are coupled to the offshore wind turbine by a support beam that is configured to be, in use, above the sea level.

24. The offshore wind turbine of claim 23 wherein each turbine comprises a foil support for supporting the respective plurality of foils via a respective plurality of foil connections, and wherein the foil support is configured to be movable up and down relative to the sea bed to lift the foil connections out of the water, wherein each of the first and second plurality of foils are only connected to the respective foil support at a proximal end that is distal to the sea bed in use.

25. (canceled)
